(19) United States
(12) Patent Application Publication
(10) Pub. No.: US 2026/0184427 A1
(43) Pub. Date: Jul. 2, 2026

(54) INFLIGHT ENTERTAINMENT SYSTEM PROVIDING INFORMATION TO CREW THROUGH AUGMENTED REALITY HEADSETS

(71) Applicant: Thales Avionics, Inc., Irvine, CA (US)

(72) Inventors: Yann NICOLAS, Melbourne, FL (US); Michael DIPPOLD, Fullerton, CA (US)

(21) Appl. No.: 19/051,830

(22) Filed: Feb. 12, 2025

Related U.S. Application Data
(60) Provisional application No. 63/740,519, filed on Dec. 31, 2024.

(51) Int. Cl. B64D 11/00; G01S 5/02; G02B 27/01; G06F 3/01; G06V 10/70; G06V 20/20

(52) U.S. Cl. CPC B64D 11/0015; G01S 5/0289; G02B 27/017; G06F 3/011; G06V 10/70; G06V 20/20

(57) ABSTRACT

An aircraft inflight entertainment (IFE) system includes an IFE controller operative to route entertainment content through at least one cabin communication network to seat video display units and/or to portable electronic devices. The IFE system also includes an augmented reality (AR) headset manager operative to determine location of an AR headset relative to physical features of the cabin, and to provide the determined location of the AR headset to the IFE controller. The IFE controller generates AR information based on the determined location of the AR headset, and communicates the AR information through the at least one cabin communication network to the AR headset for display as an augmented reality image overlaid on a real-world image viewed through the AR headset.

### CROSS REFERENCE TO RELATED APPLICATION

The present application claims priority to U.S. Provisional Patent Application Ser. No. 63/740,519, filed on Dec. 31, 2024, the disclosure of which is incorporated herein by reference in its entirety.

### TECHNICAL FIELD

The present disclosure relates to inflight entertainment systems and their operation with various types of mobile electronic devices that can be used during flights.

### BACKGROUND

Cabin crew members are being tasked with an increasing number of responsibilities during flights, reflecting a shift towards enhancing both safety and passenger experience. Beyond their traditional roles, crew members now conduct comprehensive pre-flight safety checks, ensuring that all emergency equipment is in working order and that the cabin is secure. Moreover, there is a growing emphasis on personalized service within the cabin. Crew members are encouraged to address passengers by their names, creating a more welcoming and personalized atmosphere. They are trained to become aware of passengers'preferences and special needs, such as dietary restrictions, mobility assistance, or specific requests, and to offer proactive assistance throughout the flight.

This approach not only aims to provide a more comfortable and enjoyable experience for passengers but also helps to build a stronger rapport between the crew and passengers. By combining these enhanced safety measures with personalized service, airlines strive to maintain high standards of efficiency while significantly improving the overall passenger experience.

### SUMMARY

The following disclosure describes an aircraft inflight entertainment (IFE) system. The IFE system includes an IFE controller operative to route entertainment content through at least one cabin communication network to seat video display units (SVDUs) and/or to portable electronic devices (PEDs). The IFE system also includes an augmented reality (AR) headset manager operative to determine location of an AR headset relative to physical features of the cabin, and to provide the determined location of the AR headset to the IFE controller. The IFE controller is further operative to generate AR information based on the determined location of the AR headset, and to communicate the AR information through the at least one cabin communication network to the AR headset for display as an augmented reality image overlaid on a real-world image viewed through the AR headset.

Other related embodiments are directed to a method performed by an aircraft inflight entertainment IFE system. The method includes routing entertainment content from an IFE controller through at least one cabin communication network to seat video display units and/or to portable electronic devices. The method also includes determining location of an AR headset relative to physical features of the cabin and providing the determined location of the AR headset to the IFE controller. The method also including generating AR information based on the determined location of the AR headset, and communicating the AR information through the at least one cabin communication network to the AR headset for display as an augmented reality image overlaid on a real-world image viewed through the AR headset.

Other vehicle entertainment systems and corresponding methods and computer program products according to embodiments of the invention will be or become apparent to one with skill in the art upon review of the following drawings and detailed description. It is intended that all such additional systems, methods, and computer program products be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a component block diagram of an aircraft IFE system with mobile AR headsets and an AR headset manager, a satellite communication network, and a ground system, which are configured to operate in accordance with various embodiments of the present disclosure;

FIG. 2 illustrates an example aircraft cabin environment and AR headset localization features in accordance with various embodiments of the present disclosure;

FIG. 3 illustrates an example illustration of an overhead view of an aircraft cabin environment where RF positioning is being performed to assist the AR headset manager in determining the location of the AR headset in accordance with various embodiments of the present disclosure;

FIG. 4 provides an illustration of reference axes which the AR headset cabin positioning model defines in the cabin based on seat placards and arrange of seats and aisles in accordance with various embodiments of the present disclosure;

FIG. 5 illustrates an example of a machine learning model (i.e., AR headset cabin positioning model) that is trained to recognize patterns of cabin features and objects in the process video frames to relative to the 3D model of cabin features and LOPA 520, according to some embodiments.

### DETAILED DESCRIPTION

In the following detailed description, numerous specific details are set forth in order to provide a thorough understanding of example aspects of the present invention. However, it will be understood by those skilled in the art that the present invention may be practiced without these specific details. In other instances, well-known methods, procedures, components and circuits have not been described in detail so as not to obscure the present invention.

As explained above, there is a need to assist aircraft crew members with performing their duties through the use of augmented reality (AR) headsets. Airlines may provide mobile AR headsets to cabin crew members to assist them in performing their duties. The AR headsets are configured to allow crew members to view the aircraft cabin while being assisted by computer generated information which is overlaid on their view using, for example, see-through display screens (e.g., META ORION brand AR glasses). The integration of AR headsets into the daily operations of cabin crew has the potential to revolutionize in-flight service and safety procedures. AR headsets can provide real-time information overlays, allowing crew members to access passenger details, seating arrangements, and special requests without needing to consult physical documents. This hands-free access to information can enhance efficiency and ensure that passenger needs are met promptly and accurately. Additionally, AR can assist in navigation within the aircraft, highlighting emergency exits and equipment locations, thereby improving the crew's ability to respond swiftly in critical situations.

AR headsets, on the other hand, offer immersive training experiences that can significantly enhance the preparedness of cabin crew. Through AR simulations, crew members can practice emergency procedures, customer service scenarios, and routine tasks in a controlled, virtual or augmented environment. This type of training can be more effective than traditional methods, as it allows for repeated practice and immediate feedback in a risk-free setting. By experiencing a wide range of scenarios, from turbulence to medical emergencies, crew members can build confidence and competence, ensuring they are well-equipped to handle real-life situations.

AR headsets can enable cabin crew to provide more personalized service through crew immediate access to passenger preferences, pending requests, and histories. AR headsets may be used to facilitate language translation, helping crew members communicate more effectively with passengers from diverse backgrounds and/or with passengers who are hearing impaired (e.g., display sign language prompts for crew to perform). The adoption of AR by cabin crew can lead to higher levels of service, increased safety, and a more seamless and enjoyable flight experience for passengers.

Despite the numerous advantages of AR headsets for cabin crew, determining location (localization) of an AR headset in a congested cabin environment presents significant challenges. The confined space of an aircraft cabin, coupled with the movement of passengers and crew, can interfere with the ability to determine where an AR headset is located and which passenger a crew member is interacting with. For instance, AR headsets could rely on precise spatial mapping to overlay information correctly (e.g., information relevant to a passenger who a crew member is looking at), but the dynamic and crowded nature of the cabin can lead to errors in positioning and determination of relevant information for display. This can result in incorrectly determined information and/or misaligned information overlays, which may confuse rather than assist the crew.

Moreover, the physical constraints of the cabin environment can hinder the effective localization and related use of AR headsets. AR training typically requires a certain amount of space for movement and interaction, which is not available in the narrow aisles and limited space of an aircraft. These localization issues need to be addressed to fully harness the potential of AR technologies for cabin crew, ensuring that these tools enhance rather than impede their performance.

Airlines may also provide the mobile AR headsets to passengers for temporary use during a flight, for use throughout a multi-flight trip including airport layover(s) (e.g., passenger transports the AR headset from one flight to the next), and/or during a round-trip including roundtrip destinations and/or multi-city destinations (e.g., passenger keeps the AR headset for the trip duration and returns upon arrival at the home airport). Moreover, airlines can loan mobile AR headsets to passengers to temporarily try-out during a flight and/or trip with the option to buy ownership during or after the trip. Airlines can thereby improve passenger travel experiences and create new ways of monetizing those experiences.

As will be described in further detail below, operational embodiments enable airlines to securely track location of AR headsets in an airline environment (e.g., localization of the AR headsets to one or more cabin location reference coordinate systems). The location of an AR headset may include its spatial location (where is the AR headset spatially located with the cabin) and may further include its angular orientation (e.g. in what direction is the AR headset oriented relative to the cabin).

Before discussing the example operations for determining location of AR headsets in an aircraft environment, an overview is provided of example components of aircraft and ground communication systems that can be used in accordance with some embodiment of the present disclosure.

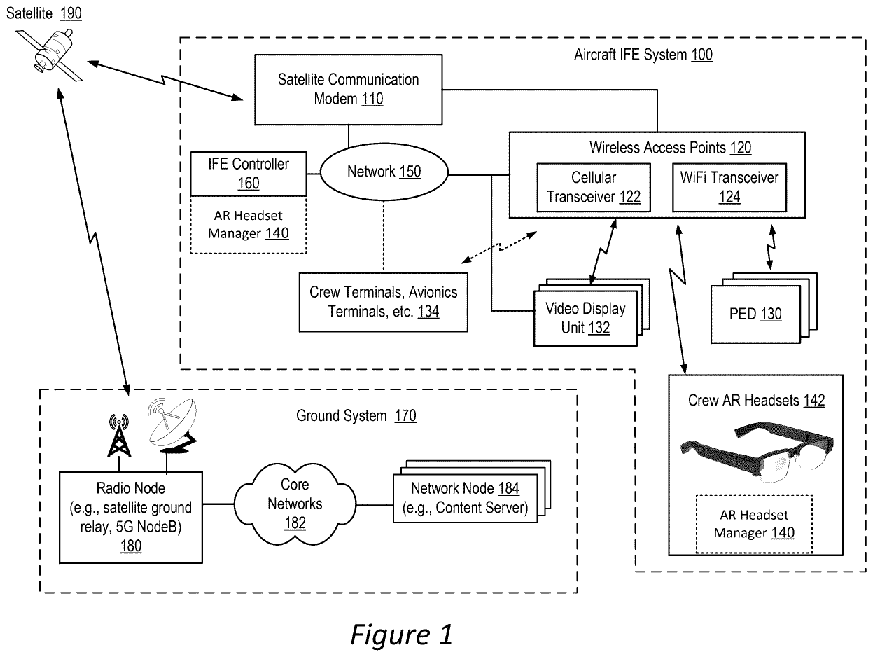

FIG. 1 illustrates a component block diagram of an aircraft IFE system 100 with mobile AR headsets 142 and an AR headset manager 140, a satellite communication network 190, and a ground system 170 which includes network nodes 184 (e.g., content servers, etc.), which are configured to operate in accordance with various embodiments of the present disclosure.

Although embodiments herein are primarily described in the context of in-flight entertainment solutions for an aircraft, the invention is not limited thereto. Instead, these and other related embodiments may be used with other types of vehicles, including, without limitation, ships (e.g., cruise ships), trains, subways, and buses. Accordingly, although various embodiments are described in the example context of involving passengers and crew, these and other embodiments can more generally be used by any persons (“users”). Accordingly, the terms passenger and user are used interchangeably without limitation.

Referring to FIG. 1, the IFE system 100 communicates with the ground system 170 using various communication technologies, e.g., proprietary satellite protocols, 3GPP 5G protocols, etc. More particularly, the example IFE system 100 includes a satellite communication modem 110 that transmits and receives signaling through one or more satellite antennas which is relayed by satellite(s) 190 to and from a ground-based radio node 180 (e.g., satellite gateway and relay, 5G NodeB, etc.).

In the IFE system 100, content received by the satellite communication modem 110 through satellite aperture antenna(s) are transported via RF link or Common Public Radio Interface (CPRI) interface (e.g., Ethernet or fiber optic links) and one or more networks 150 to an IFE controller 160 (also IFE controller) for possible distribution through the network(s) 150 and/or wireless access points 120 to SVDUs 132, passenger electronic devices (PEDs) 130, mobile AR headsets 142, crew terminals 134, and other avionics terminals. The wireless access points 120 can include WiFi transceivers 124 (e.g., IEEE 802.11) or cellular transceivers 122.

The IFE controller 160 can communicate with ground-based network nodes 184, e.g., IFE controllers (e.g., over-the-top servers providing content such as movies, TV programming, games, e-books, Internet webpages, etc.), through core networks 182 (e.g., private networks and/or public networks such as the Internet) and the radio node 180, etc. The IFE controller 160 can provide content from the network nodes 184 to the SVDUs 132, PEDs 130, and mobile AR headsets 142, and may alternatively or additionally provide similar types of content that has been previously loaded into onboard memory.

In accordance with present embodiments, the IFE controller 160 can be configured to communicate with various types of mobile AR headsets 142 to provide operational functionality to passengers. For example, the IFE controller 160 can operate to stream movies and other content to AR headsets 142, tablet computers, etc. for display and audio playout to passengers through noise cancelling headphones. Similarly, the IFE controller 160 may download executable applications (e.g., games) to XR headsets 142, gaming consoles, tablet computers, etc. for playing by passengers.

Passengers can thereby be provided unique experiences which may include playing aircraft themed games through AR headsets 142 that may adapt the gameplay based on the aircraft configuration (e.g., type of aircraft and seating location of passenger), present flight location, view outside the aircraft of the surrounding airspace, ground and/or space, etc.

Through AR headsets 142, crew members can be provided with information to assist with their various tasks such as safety information, passenger information, flight information, etc.

Although the AR headset manager 140 is illustrated as a discrete box in FIG. 1 for ease of illustration and description, its functionality may be at least partially integrated within the AR headset(s) 142, the IFE controller 160, and/or one or more other electronic components of the IFE system 100. For example, an AR headset 142 may have sufficient processing throughput and memory capacity to perform operational instructions according to at least some of the functionality disclosed herein for the AR headset manager 140. The AR headset manager 140 operational functionality may therefore be implemented entirely in the AR headset 142 or the IFE controller 160, or may be implemented in-part in both the AR headset 142 and the IFE controller 160.

The AR headset manager 140 may operate to monitor establishment and maintenance of communication connections with AR headsets 142, determine location of the AR headsets 142 within the cabin, provide information for display on the AR headsets 142, etc.

For example, the AR headset manager 140 (or a component thereof in the IFE controller 160, SVDUs 132 and/or wireless access points 120) can manage setup and maintenance of Bluetooth, WiFi, or other wireless communication connections and/or wired communication (e.g., USB wired interfaces of SVDUs 132) with mobile AR headsets 142.

Alternatively or additionally, the IFE controller 160 can operate to establish communication connections through at least one communication network (e.g., network 150, WAPs 120, SVDUs 132, etc.) with the mobile AR headsets 142 to provide vehicle entertainment services to passengers, and to route entertainment content through the communication connections to the mobile AR headsets 142 responsive to commands received from the mobile AR headsets 142.

Various embodiments of the present disclosure are directed to an IFE system 100 that includes the IFE controller 160 which is operative to route entertainment content through at least one cabin communication network to seat video display units (SVDUs) 132 and/or to portable electronic devices (PEDs) 130. The IFE system 100 also includes the AR headset manager 140 which is operative to determine location of an AR headset 142 relative to physical features of the cabin, and to provide the determined location of the AR headset 142 to the IFE controller 160. The IFE controller 160 is further operative to generate AR information based on the determined location of the AR headset 142, and to communicate the AR information through the at least one cabin communication network 150 to the AR headset 142 for display as an augmented reality image overlaid on a real-world image viewed through the AR headset 142.

In some embodiments, the AR headset manager 140 is further operative to process video frames received from a camera of the AR headset 142 through an AR headset cabin positioning model to determine the location of the AR headset relative to physical features of the cabin. The AR headset cabin positioning model correlates a positional pattern of features identified in the video frames to a pattern defined in the AR headset cabin positioning model of known (defined in memory and through programmatic operations) features of the cabin and corresponding cabin locations of the known features.

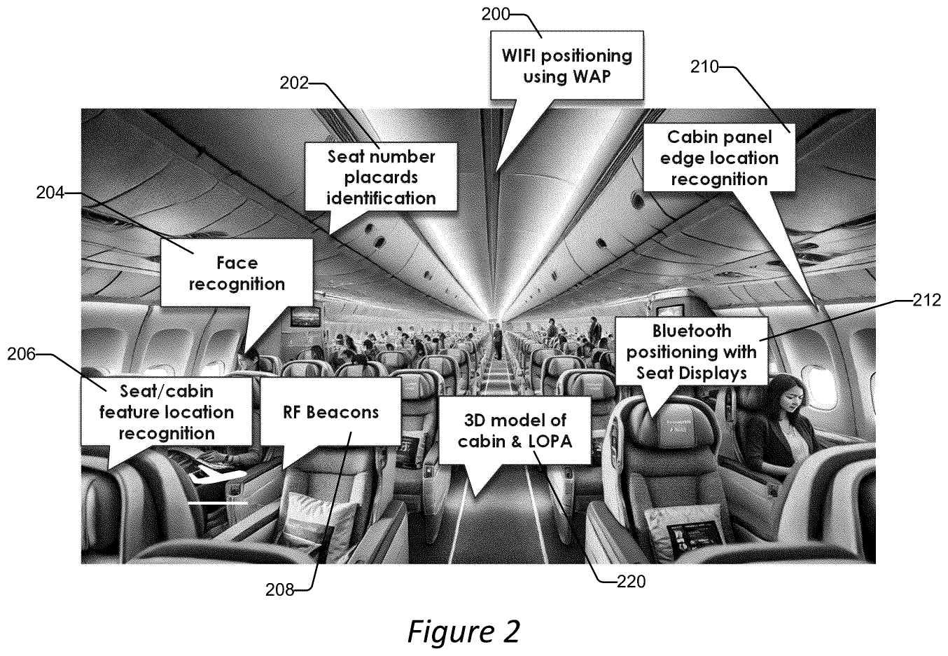

FIG. 2 illustrates an example aircraft cabin environment and AR headset localization features in accordance with various embodiments of the present disclosure.

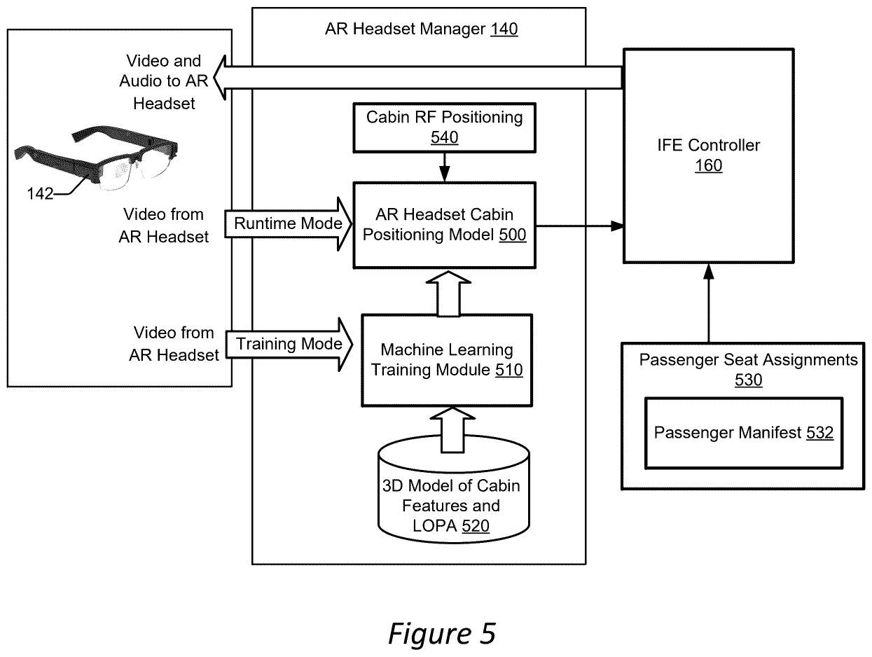

The video captured by one or more cameras integrated into the AR headset worn by a crew member is processed through an AR headset cabin positioning model 500 (see FIG. 5). The model 500 may be used by the AR headset manager to determine location of an AR headset relative to physical features of the cabin, and to provide the determined location of the AR headset to the IFE controller. The model 500 has been trained or configured using a three-dimensional (3D) model 520 (see FIG. 5) of the cabin's features which may include a Layout of Passenger Accommodations (LOPA) 220, which provides a comprehensive blueprint of the aircraft's interior. The primary function of model 500 is to determine the precise position (determined location) of the AR headset relative to various cabin features, including passenger seats. This positioning (determined location) includes not only the cabin location relative to the seats, forming a cabin reference system, but may also include the angular orientation of the AR headset, indicating the direction in which the headset is looking.

The LOPA 220 can serve as a detailed schematic of the aircraft's interior, indicating the relative arrangement of seats, galleys, lavatories, and other essential cabin features. The LOPA 220 can be used by the AR headset cabin positioning model 500 (see FIG. 5) to operate to recognize location of specific cabin features in the cabin.

Other features observed in processed video frames from the AR headset may also be identified relative to the 3D model and LOPA to provide the AR headset manager the precise location and pose of the AR headset. For instance, the AR headset manager can identify cabin panel edge locations 210, seat number placards 202, seat/cabin feature location recognition 206, and other significant features such as the edges of overhead storage bins. By recognizing these features, the AR headset cabin positioning model 500 (see FIG. 5) can accurately determine the AR headset's position within the cabin, ensuring that the information displayed to the crew member is contextually relevant and precise.

In other words, a pattern defined in the AR headset cabin positioning model and identified by the AR headset manager 140 may indicate relative locations in three dimensional space of the cabin of at least two of: known seat number placards, known seat features, known cabin windows, known overhead storage bin edges, and known cabin panel edges.

Moreover, the AR headset cabin positioning model 500 (see FIG. 5) is capable of recognizing the relative positioning between various locations within the cabin and the array of cabin features as viewed through the AR headset. This includes the alignment of features such as cabin seats, cabin panel edges, overhead storage bin edges, and cabin windows. By understanding the spatial relationships between these elements, the model can provide a comprehensive and accurate representation of the cabin environment. This capability is essential for enhancing the situational awareness of the crew members, allowing them to navigate the cabin more efficiently and respond to passenger needs with greater precision.

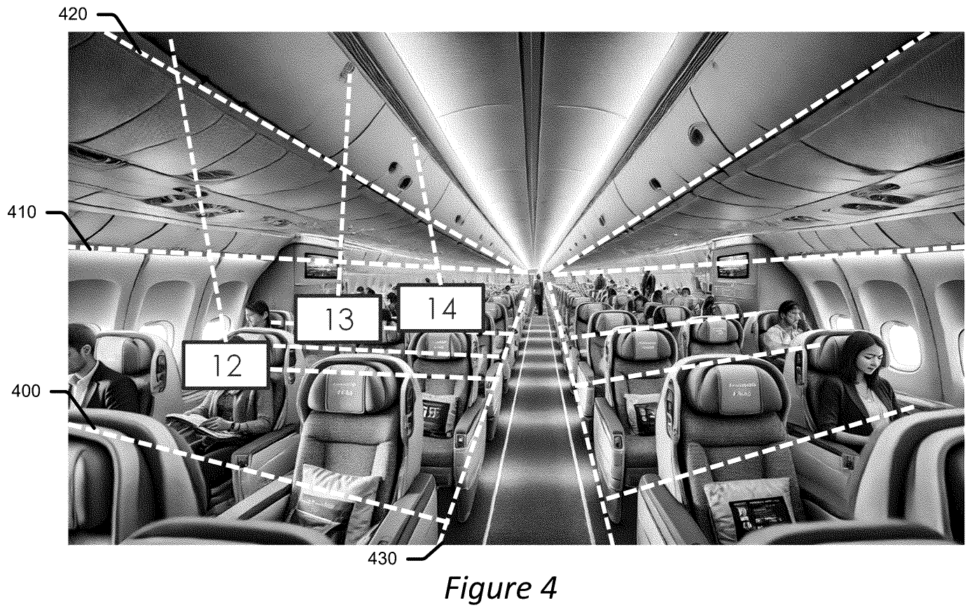

FIG. 4 provides an illustration of reference axes which the AR headset cabin positioning model 500 defines in the cabin based on seat placards and arrange of seats and aisles in accordance with various embodiments of the present disclosure. The model 500 operates to process video frames received from the AR headset to identify location and meaning of seating placards, such as those labeled 12, 13, and 14, which are mounted on overhead structures within the cabin. These placards serve along with the arrangement and orientation of viewed seating and aisles serve as various references for determining the precise position of the AR headset within the cabin environment.

In addition to identifying seating placards, the AR headset cabin positioning model 500 also detects the locations of several key cabin reference axes. These axes are depicted in the figure by dashed lines and include the seat row reference axis 400, which runs parallel to the rows of seats; the upper wall panel reference axis 410, which aligns with the upper panels of the cabin walls; the overhead storage bin reference axis 420, which corresponds to the positioning of the overhead storage bins; and the aisle edge reference axis 430, which marks the edges of the cabin aisles.

By identifying these reference axes, the model 50 can establish a comprehensive spatial localization framework within the cabin. This framework is then used for accurately mapping the AR headset's position relative to the cabin's features. The seat row reference axis 400, for instance, helps in determining the headset's location along the aisle of seating rows, while the upper wall panel reference axis 410 aids in vertical positioning relative to the cabin walls. Similarly, the overhead storage bin reference axis 420 and the aisle edge reference axis 430 provide additional spatial context that enhances the overall accuracy of the positioning model.

The integration of these reference points and axes into the AR headset cabin positioning model 500 ensures a robust and reliable method for tracking the headset's location. This capability is particularly important in environments where precise spatial awareness is crucial, such as in augmented reality applications used for training, simulation, or entertainment within an aircraft cabin. By leveraging these detailed positional references, the model can deliver a highly accurate and immersive AR experience for users.

Referring to FIG. 2, facial recognition 204 may also be used to determine location of an AR headset relative to a known passenger seated in the passenger's assigned seat. In some of these embodiments, the IFE controller is further operative to generate the AR information based on identifying a seat location in the cabin, obtaining from a repository containing a passenger manifest information identifying a passenger, and adding the information identifying the passenger to the AR information.

IFE controller may be further operative to perform operations including determine based on the location of the AR headset at least seat identifier that the AR headset is looking at. The operations also include to query a passenger manifest using the at least one seat identifier to obtain information identifying characteristics of at least one passenger assigned to the at least one seat identifier. The operations may also include to compare the identified characteristics of the at least one passenger to observed characteristics of at least one passenger captured in the video frames received from the camera of the AR headset, to identify a passenger. The operations may also include to add an identity of the passenger to the AR information.

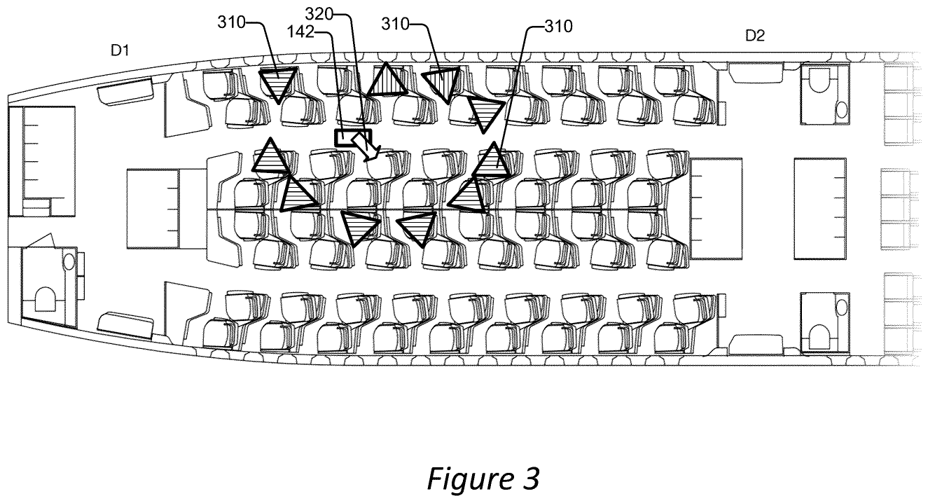

RF positioning may also be used to assist localization of the AR headset. FIG. 3 illustrates an example illustration of an overhead view of an aircraft cabin environment where RF positioning is being performed to assist the AR headset manager in determining the location of the AR headset 142.

In some of these embodiments, the AR headset manager is further operative to determine an initial estimate of location of the AR headset relative to physical features of the cabin based on triangulation of radio frequency RF signals received from RF transceivers at known locations in the cabin. The operations may include using the initial estimate of location of the AR headset during the processing of the video frames through the AR headset cabin positioning model to generate a refined estimate of location of the AR headset. The operations may include providing the refined estimate of location of the AR headset to the IFE controller.

The RF transceivers may include a plurality of WiFi transceivers, Bluetooth transceivers, and/or RF beacons having locations in the cabin that are known to the AR headset cabin positioning model.

The AR headset manager also use RF positioning operations to approximate the location of the AR headset, using for example, received signal strength measurements and/or triangulation of RF signals received from known locations of beacons 208, locations of WAPs 200, and/or Bluetooth transceivers 212 at seat displays. However, these RF positioning operations may not be sufficiently accurate especially when performed in the noisy RF environment of an aircraft cabin.

In FIG. 3, the video feed from the AR headset is processed through the AR headset cabin positioning model 500 (as depicted in FIG. 5) to ascertain the position of the AR headset relative to various cabin features, such as passenger seats. FIG. 3 depicts seats arranged within the cabin, cabin doors D1 and D2, bulkheads and other structures of the cabin. Due to the inherent symmetry of the cabin, certain patterns may repeat in different spaced-apart regions. This repetition can cause the AR headset cabin positioning model 500 to produce multiple potential matches, or false positives, for the headset's location, as multiple areas within the cabin may present sufficiently similar views to the AR headset.

To mitigate this issue, RF ranging technology can be employed to determine a general location within the cabin. For example, in FIG. 3 the RF ranging based location of an XR headset 142 is generally determined to be in an area indicated by possible locations 310. This general location can then be used to narrow down the area that the AR headset cabin positioning model 500 considers when identifying the headset's precise location. By restricting the search area within the model 500, the likelihood of false positives is reduced, and the computational complexity of processing each subsequent video frame from the AR headset's camera is significantly decreased (e.g., search only in a subset of the model 500 relevant to the general (RF approximated) location within the cabin). The model 500 is then used to more accurately determine the location of the headset 142 as being at 320, where the location determined by the model 500 identifies both the spatial location within the cabin and a direction in which the crew member is looking. This approach not only enhances the accuracy of the positioning model but also improves the overall efficiency of the system.

The integration of such advanced positioning technology into IFE systems represents a significant advancement in the tools available to cabin crew. It ensures that the augmented information overlay is relevant to where the crew member is looking and can be accurately aligned relative to what the crew member sees, thereby reducing the likelihood of errors and enhancing the overall effectiveness of the AR system. This technology not only improves the operational efficiency of the crew but also contributes to a safer and more streamlined in-flight experience for passengers. As the aviation industry continues to embrace innovative technologies, the use of AR headsets equipped with advanced positioning technologies is likely to become a standard practice, setting new benchmarks for service and safety in the skies.

The AR headset cabin positioning model 500 may be trained using multiple methods, such as using machine learning training. In these embodiments, the AR headset manager includes a machine learning training model operative in a training mode to train the AR headset cabin positioning model based on identifying correlations between modeled features, which are defined in a 3D model of the cabin, and a stream of video frames received from a camera of a training AR headset transported by a person along cabin aisles, galleys, and defined cabin areas.

The machine learning training model may be operative in the training mode to train the AR headset cabin positioning model to indicate relative locations in three dimensional space of the cabin of features observed in video frames received from the camera of the training AR headset which are identified as corresponding to at least two of: seat number placards, seat features, cabin windows, overhead storage bin edges, and cabin panel edges.

The machine learning training model may be further operative in the training mode to train the AR headset cabin positioning model based on comparing the features observed in video frames received from the camera of the training AR headset to information obtained from a repository of information defining a layout of passenger accommodations.

FIG. 5 illustrates an example of a machine learning model (i.e., AR headset cabin positioning model 500) that is trained to recognize patterns of cabin features and objects in the process video frames to relative to the 3D model of cabin features and LOPA 520, according to some embodiments.

Referring to FIG. 5, The AR headset manager 140 can include a machine learning training module 510 that operates in a training mode to train an AR headset cabin positioning model 500 using a 3D model of cabin features and LOPA 520. The 3D model of cabin features and LOPA 520 can function as a repository storing a 3D model of cabin features and LOPA which may identify location and characteristics of all definable features of a specific aircraft cabin, such as cabin panel edge locations, seat number placards, seat/cabin feature location recognition, the edges of overhead storage bins and other significant features.

The training mode may be performed during the initial configuration of a cabin and/or by cabin crew or maintenance crew while the cabin is empty of passengers before or between flights. During the training mode, a person can wear the AR headset 142 while walking along aisles and through other crew accessible cabin spaces of the cabin. The training mode may be reperformed to replace, retrain, or refine the AR headset cabin positioning model 500 any time cabin features are updated or changed, e.g., when seat locations are changed, bulkheads are moved, overhead storage bins are replaced, etc.

In this manner, the AR headset cabin positioning model 500 can be trained through supervised learning using video from from the AR headset 142 to recognize with high accuracy the features observable in the video frames using the 3D model of cabin features and LOPA 520. The AR headset cabin positioning model 500 relates cabin features to locations in the cabin. The AR headset manager may refine the output of or guide the determination of the AR headset cabin positioning model 500 using cabin RF positioning 540 as discussed above.

Additionally, as discussed in further detail above, the IFE controller 160 may obtain passenger seat assignments and seat layout map 530 including a passenger manifest 532 to further refine localization of the AR headset through facial recognition. The IFE controller 160 provides AR information to the AR headset based on the determination of location of the AR headset 142 and/or direction the AR headset 142 is looking by the AR headset cabin positioning model 500.

The IFE controller 160 may, for example, use the spatial location and direction of look of the AR headset 142 to determine which seat the crew member is looking toward. The IFE controller 160 can use the passenger manifest 532 to look-up information for the passenger who is assigned to that seat, and then generate the AR information based on the IFE controller's determinations. For example, the IFE controller 160 may display through the AR headset 142 a passenger's name, dietary preferences/restrictions, passenger requested/preferred services, airline loyalty information, passenger trip itinerary, etc.

The AR headset cabin positioning model 500 may include a neural network model having hierarchical layers of summing nodes with weights and firing thresholds that are trained by the machine learning training module 510 to perform the matching and correlation. Alternatively or additionally, the AR headset cabin positioning model 500 may include program instructions that logically match patterns of features in the video frames from the AR headset 142 to corresponding features and learned from the 3D model 520.

Although the AR headset manager 140 is illustrated as a discrete box in FIG. 5 for ease of illustration and description, its functionality may be at least partially integrated within the AR headset 142 and/or the IFE controller 160. For example, the AR headset 142 may have sufficient processing throughput and memory capacity to perform operational instructions according to at least some of the functionality disclosed herein for the AR headset manager 140. The AR headset manager 140 operational functionality may therefore be implemented entirely in the AR headset 142 or the IFE controller 160, or may be implemented in-part in both the AR headset 142 and the IFE controller 160.

For example, the 3D model of cabin features and LOPA 520 may reside in mass memory storage of the IFE controller 160 or a network node of the ground system 170. The IFE controller 160 may perform operations for functionality of the machine learning training module 510 to train the AR headset cabin positioning model 500 which may reside in local memory of the AR headset 142. During run time mode the AR headset 142 can process video from its camera(s) through its local AR headset cabin positioning model 500 to determine its spatial location and direction of look which are output to the IFE controller 160, for the IFE controller 160 to use to generate the AR information provided to the AR headset 142 for display as an augmented overlay on what the crew member views through the AR headset 142.

### FURTHER DEFINITIONS AND EMBODIMENTS

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

What is claimed is:

1. An aircraft inflight entertainment (IFE) system comprising:
an IFE controller operative to route entertainment content through at least one cabin communication network to seat video display units (SVDUs) and/or to portable electronic devices (PEDs); and
an augmented reality (AR) headset manager operative to determine location of an AR headset relative to physical features of the cabin, and to provide the determined location of the AR headset to the IFE controller,
wherein the IFE controller is further operative to generate AR information based on the determined location of the AR headset, and to communicate the AR information through the at least one cabin communication network to the AR headset for display as an augmented reality image overlaid on a real-world image viewed through the AR headset.

2. The IFE system of claim 1, wherein the AR headset manager is further operative to process video frames received from a camera of the AR headset through an AR headset cabin positioning model to determine the location of the AR headset relative to physical features of the cabin, wherein the AR headset cabin positioning model correlates a positional pattern of features identified in the video frames to a pattern defined in the AR headset cabin positioning model of known features of the cabin and corresponding cabin locations of the known features.

3. The IFE system of claim 2, wherein the pattern defined in the AR headset cabin positioning model indicates relative locations in three dimensional space of the cabin of at least two of: known seat number placards, known seat features, known cabin windows, known overhead storage bin edges, and known cabin panel edges.

4. The IFE system of claim 2, wherein the AR headset manager comprises a machine learning training model operative in a training mode to train the AR headset cabin positioning model based on identifying correlations between modeled features, which are defined in a three dimensional (3D) model of the cabin, and a stream of video frames received from a camera of a training AR headset transported by a person along cabin aisles, galleys, and defined cabin areas.

5. The IFE system of claim 4, wherein the machine learning training model is operative in the training mode to train the AR headset cabin positioning model to indicate relative locations in three dimensional space of the cabin of features observed in video frames received from the camera of the training AR headset which are identified as corresponding to at least two of: seat number placards, seat features, cabin windows, overhead storage bin edges, and cabin panel edges.

6. The IFE system of claim 5, wherein the machine learning training model is further operative in the training mode to train the AR headset cabin positioning model based on comparing the features observed in video frames received from the camera of the training AR headset to information obtained from a repository of information defining a layout of passenger accommodations.

7. The IFE system of claim 2, wherein the AR headset manager is further operative to:
determine an initial estimate of location of the AR headset relative to physical features of the cabin based on triangulation of radio frequency (RF) signals received from RF transceivers at known locations in the cabin;
use the initial estimate of location of the AR headset during the processing of the video frames through the AR headset cabin positioning model to generate a refined estimate of location of the AR headset; and
provide the refined estimate of location of the AR headset to the IFE controller.

8. The IFE system of claim 7, wherein the RF transceivers comprise a plurality of WiFi transceivers, Bluetooth transceivers, and/or RF beacons having locations in the cabin that are known to the AR headset cabin positioning model.

9. The IFE system of claim 1, wherein the IFE controller is further operative to generate the AR information based on identifying a seat location in the cabin, obtaining from a repository containing a passenger manifest information identifying a passenger, and adding the information identifying the passenger to the AR information.

10. The IFE system of claim 2, wherein the IFE controller is further operative to:
determine based on the location of the AR headset at least seat identifier that the AR headset is looking at;
query a passenger manifest using the at least one seat identifier to obtain information identifying characteristics of at least one passenger assigned to the at least one seat identifier;
compare the identified characteristics of the at least one passenger to observed characteristics of at least one passenger captured in the video frames received from the camera of the AR headset, to identify a passenger; and
add an identity of the passenger to the AR information.

11. A method performed by an aircraft inflight entertainment (IFE) system comprising:
routing entertainment content from an IFE controller through at least one cabin communication network to seat video display units (SVDUs) and/or to portable electronic devices (PEDs); and
determining location of an augmented reality (AR) headset relative to physical features of the cabin, and providing the determined location of the AR headset to the IFE controller,
generating AR information based on the determined location of the AR headset, and communicating the AR information through the at least one cabin communication network to the AR headset for display as an augmented reality image overlaid on a real-world image viewed through the AR headset.

12. The method of claim 11, further comprising:
processing video frames received from a camera of the AR headset through an AR headset cabin positioning model to determine the location of the AR headset relative to physical features of the cabin, wherein the AR headset cabin positioning model correlates a positional pattern of features identified in the video frames to a pattern defined in the AR headset cabin positioning model of known features of the cabin and corresponding cabin locations of the known features.

13. The method of claim 12, further comprising:
indicating relative locations in three dimensional space of the cabin of at least two of: known seat number placards, known seat features, known cabin windows, known overhead storage bin edges, and known cabin panel edges.

14. The method of claim 12, further comprising:
training the AR headset cabin positioning model in a training mode based on identifying correlations between modeled features, which are defined in a three dimensional (3D) model of the cabin, and a stream of video frames received from a camera of a training AR headset transported by a person along cabin aisles, galleys, and defined cabin areas.

15. The method of claim 14, further comprising:
training the AR headset cabin positioning model in the training mode to indicate relative locations in three dimensional space of the cabin of features observed in video frames received from the camera of the training AR headset which are identified as corresponding to at least two of: seat number placards, seat features, cabin windows, overhead storage bin edges, and cabin panel edges.

16. The method of claim 15, further comprising:
training the AR headset cabin positioning model in the training mode based on comparing the features observed in video frames received from the camera of the training AR headset to information obtained from a repository of information defining a layout of passenger accommodations.

17. The method of claim 12, further comprising:
determining an initial estimate of location of the AR headset relative to physical features of the cabin based on triangulation of radio frequency (RF) signals received from RF transceivers at known locations in the cabin;
using the initial estimate of location of the AR headset during the processing of the video frames through the AR headset cabin positioning model to generate a refined estimate of location of the AR headset; and
providing the refined estimate of location of the AR headset to the IFE controller.

18. The method of claim 17, wherein the RF transceivers comprise a plurality of WiFi transceivers, Bluetooth transceivers, and/or RF beacons having locations in the cabin that are known to the AR headset cabin positioning model.

19. The method of claim 11, further comprising:
generating the AR information based on identifying a seat location in the cabin, obtaining from a repository containing a passenger manifest information identifying a passenger, and adding the information identifying the passenger to the AR information.

20. The method of claim 12, further comprising:
determining based on the location of the AR headset at least seat identifier that the AR headset is looking at;
querying a passenger manifest using the at least one seat identifier to obtain information identifying characteristics of at least one passenger assigned to the at least one seat identifier;
comparing the identified characteristics of the at least one passenger to observed characteristics of at least one passenger captured in the video frames received from the camera of the AR headset, to identify a passenger; and
adding an identity of the passenger to the AR information.
